(19) United States
(12) Patent Application Publication
(10) Pub. No.: US 2011/0197805 A1
(43) Pub. Date: Aug. 18, 2011

(54) Triangular Bookmark

(76) Inventor: Zhao Wang, Flushing, NY (US)

(21) Appl. No.: 12/707,813

(22) Filed: Feb. 18, 2010

(51) Int. Cl. B42D 9/00

(52) U.S. Cl. 116/237

(57) ABSTRACT

The bookmark being described is shaped like a triangle with an opening on the longest side. The edge of a book's inner page can be inserted into the opening and therefore provides the reader with a bookmark. Due to the specific shape, it can prevent the bookmark from fallen off the book. The bookmark can be easily taken off and can be repeatedly used for many times. It will not leave any damages to the paper and it is easy to manufacture.

### FIELD OF INVENTION

The present invention relates to a bookmark.

### BACKGROUND OF THE INVENTION

The well known book mark is a rectangular piece of paper in which the reader can place in a book to keep the page. Even thought they are easily manufactured, they are also easily lost. There are also bookmarks with a clip. It prevents the bookmark from fallen off the page, but it leaves a mark on the page and can be easily ripped due to the fact that the clip is cut out from the bookmark body. So in order to make the common bookmarks more efficient, there has been a continuing need for improvement.

### BRIEF SUMMARY OF THE INVENTION

One objective of the present invention is to provide a bookmark that can be repeatedly used, being simple in structure, easy to manufacture and prevent the bookmark body from fallen off the page.

To achieve the above objective, the present invention provides a bookmark in the shape of a triangle. Due to most books are rectangular in shape, it can be used on books of different sizes. It includes an opening which can be easily inserted onto the corner of a page, therefore the bookmark will stay in the same place that the reader placed it and it will be very easy to find.

The bookmark can be made of plastic, metal sheet, magnet, paper, or other resilient materials.

### BRIEF DESCRIPTION OF THE DRAWING

FIG. 1 is the perspective view of the bookmark

FIG. 2 is the side view

FIG. 3 is the perspective view of the using state of the bookmark

### DETAILED DESCRIPTION OF THE INVENTION

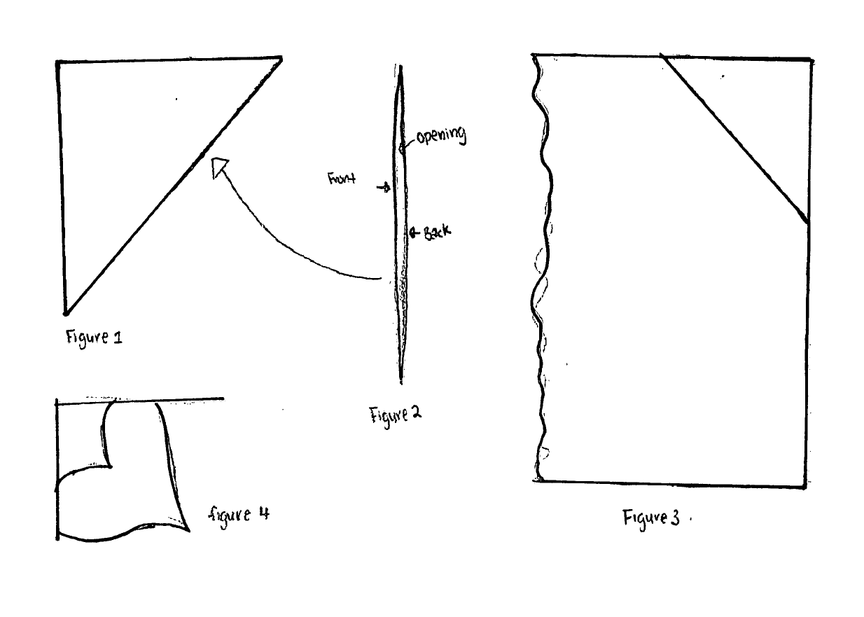

FIG. 1 shows the front view of the bookmark. It is made of bendable materials and is inserted into the book as show in FIG. 3 through the opening on the side showed in FIG. 2.

The bookmark can be made of plastic, metal sheet, magnet, paper, or other resilient materials.

The bookmark clip can be used on the inner pages or the cover page of a book without dropping off.

The bookmark can be easily removed without damaging the papers of the book.

The bookmark is removable and can be used in different books.

The bookmark can be painted with decorative patterns or made into various artistic forms. It can still fit on the corner of the book without being triangular showed in FIG. 4.

The invention claimed is:

1. A bookmark that fit on the edge of the inner page of a book. It has a front and a back side with an opening in between. It can be triangular in shape or other designs.

2. The bookmark according to claim 1, wherein the bookmark is made of plastic, metal, paper, magnet, or other resilient material.
